(19) United States
(12) Patent Application Publication
(10) Pub. No.: US 2018/0065744 A1
(43) Pub. Date: Mar. 8, 2018

(54) SUBMARINE AND FLYING AUTOMOBILE

(71) Applicant: Young Chan PARK, Hanam-si (KR)

(72) Inventor: Young Chan PARK, Hanam-si (KR)

(21) Appl. No.: 15/256,743

(22) Filed: Sep. 6, 2016

(51) Int. Cl. B64C 37/00; B63G 8/08; B64D 27/10; B64C 27/08; B63G 8/22; B63H 1/36

(52) U.S. Cl. CPC B64C 37/00; B63G 8/08; B64D 27/10; B63G 2008/002; B63G 8/22; B63H 1/36; B64C 27/08

(57) ABSTRACT

Disclosed is a submarine and flying automobile including a submarine-shaped automobile body, a waterjet installed inside the automobile body, a gas turbine engine installed inside the automobile body, a pair of tandem rotors installed at a predetermined interval at a top of the automobile body, a bow trim tank and a stern trim tank which are installed at front and rear portions of an inside of the automobile body, a pair of trim lines configured to connect the bow trim tank and the stern trim tank, and a tail wing propelling part engaged to a rear portion of the automobile body.

### BACKGROUND

The present invention relates to a submarine and flying automobile, and more detailed in which the water can be operated as a submarine, and fly on the surface of the water at a specified height from the ground like a helicopter.

As the national income increases, a variety of leisure culture are being developed. In recent years, a various of water leisure culture and the 3 surface of the South Korean land surrounded by the sea, in which trend of the development has been presented accordingly.

As an example, the submarine can be developed and operated in a way that a manned or unmanned type rides on the sea to explore or view. Unmanned submarine is mainly used to explore topography or resources of the sea. Since the manned submarine is mainly used to simply view an underwater scenery, the experience is very low efficiency which speaking from on the level of water leisure.

In order to improve the shortcomings, the Korean patent registration No. 10-1350017 describes “a manned submarine for underwater view and experience” wherein an underwater water enters a crew chamber except for the inside space of a see-through window wherein a person's upper body positions for the sake of breathing, and seawater can contact with the body of a passenger, thus providing a high stimulation type leisure experience in terms of five sense, not designed for a visible experience.

The mentioned above existing technological of submarine, however, is directed to an underwater view trip wherein most passengers are guided by the driver according to the preset road, for which not only the experiencing satisfaction of an underwater leisure is low, but also it is equipped with an internal structure which the number of passengers get in and activate. For this reason, the submarine is inevitably expensive.

Moreover, the Korean patent registration No. 10-1999-020576 describes “an amphibious automobile” which is configured to prevent the automobile from sinking underwater if an accident occurs, in which the automobile sinks underwater, thus saving passengers' lives, and the amphibious automobile can sail a predetermined distance on water, by means of which it is possible to prevent any secondary accident due to a passenger's poor swimming and any injuries.

However, as mentioned amphibious automobile is configured to move slowly underwater surface in a state where it is submerged, for which a lot of time is required. This kind of the amphibious automobile may be used only for the sake of military strategy purposes, and any leisure experience for stimulating five sense is very low, and also an individual purchase may have a limit.

Moreover, a single-user small sized flying device called “a waterjet pack” has been developed and is now commercially available, which is able to fly up to a predetermined height over water with the aid of the force of water.

The waterjet pack is able to surge up to about 9 meters using the force generating when seawater is gushed out at a time in the opposite direction after the seawater has been stored, which may be considered a perfect thrilling water leisure in terms of the water leisure view.

However, the price of such a waterjet pack is about 60,000 pound (about 107 million won), for which there may be a limit for the sake of public and expand.

### SUMMARY

Accordingly, the present invention is made in an effort to meet the demands from related industry requirements as mentioned above and existing technical problems.

It is an object of the present invention to provide a submarine and flying automobile which is able to vertically take off and land in the vertical direction on water and is able to fly low within a predetermined set height range.

It is another object of the present invention to provide a submarine and flying automobile which is able to submerge underwater at a previously set submerging depth and is able to operate to change upward and downward directions, if necessary.

It is further another object of the present invention to provide a submarine and flying automobile which is able to provide the required oxygen within a predetermined time range range during the operation of the water.

To achieve the above objects, there is provided an automobile equipped with submerging and flying functions, which may include, but is not limited to, a submarine-shaped automobile body; a waterjet which is installed inside of the automobile body and is able to vertically fly the automobile body in such a way to discharge a previously set water pressure based on a driver's manipulation; a gas turbine engine which is installed inside of the automobile body and is able to fly the automobile body in such a way to generate a predetermined magnitude of a propelling force and a lift based on a driver's manipulation; a pair of tandem rotors which are installed at a predetermined interval at the top of the automobile body and is able to fly the automobile body in such a way to generate a thrust in the vertical direction based on a driver's manipulation; a bow trim tank and a stern trim tank which are installed at the front and rear portions inside of the automobile body and are configured to store a previously set amount of water so as to adjust the buoyancy with respect to the weights of the front or rear portion of the automobile body; a pair of trim lines which are configured to connect the bow trim tank and the stern trim tank and are able to forcibly move the water stored in the bow trim tank to the stern trim tank in such a way to use a screw propeller disposed inside or forcibly move the water stored in the stern trim tank to the bow trim tank; and a tail wing propelling part which is engaged to a rear portion of the automobile body and is configured to convert the torque of an electric motor into leftward and rightward reciprocation movements using a scotch yoke during an underwater sailing, thus continuously supplying a propelling force and is able to manipulate underwater the automobile body in the vertical and horizontal directions.

Here, the tail wing propelling part may include a pair of electric motors which are able to generate a torque in a previously set direction if a current is applied; a pair of scotch yokes which are able to convert the torque generated by a pair of the electric motors into a reciprocating movement; and a pair of left and right tail wings which operate like the propelling part as the left and right tail wings continue to operate in the left and right reciprocation directions with the aid of a pair of the scotch yokes. Moreover, the automobile is able to fly over water with the aid of a propelling force from the gas turbine engine and the thrust from a pair of the tandem rotors in a state where the automobile has taken off at a previously set height using the pressure of water from the waterjet. The automobile is able to submerge in such a way that the water stored in the stern trim tank is forcibly moved to the bow trim tank in a state where the automobile body positions on the surface of water, and is able to submerge underwater from the air while manipulating the rotation directions of a pair of the tandem rotors.

The submarine and flying automobile according to the present invention has the following advantageous effects.

First, the submarine and flying automobile is able to take off up to about 10 meters and land on water in the vertical direction with the aid of an underwater motor, a hose, a waterjet, a rotation spraying plate drainage port rotation wing, and a check valve which are disposed at the automobile equipped with submerging and flying functions, and it is able to fly low at the height of 20 meters over water using a tandem rotor provided on the top of the automobile equipped with submerging and flying functions.

Second, the submarine and flying automobile according to the present invention is able to submerge underwater at the depth of about 10 meters in such a way to propel water, using a screw propeller, to a trim line configured to connect a trim tank installed at a bow and a stern, and the direction of the automobile of the present invention can be changed upward or downward or into the horizontal direction in such a way to adjust the rotation spraying plate drainage port rotation wing of the waterjet, if necessary, and it is able to sail underwater in a desired direction.

Third, the submarine and flying automobile according to the present invention may allow to supply for itself oxygen to a driver for about 5 hours without externally supplying air during the underwater sailing, thus providing a safe and new water leisure sport.

### BRIEF DESCRIPTION OF THE DRAWINGS

FIG. 1 is a perspective view illustrating the whole exterior of submarine and flying automobile according to a preferred embodiment of the present invention;

FIG. 2 is a view for describing the operation of a tail wing propeller which is used during an underwater sailing of submarine and flying automobile according to a preferred embodiment of the present invention;

FIGS. 3A and 3B are views for describing an operation wherein a rotation spraying plate drainage port rotation wing of a waterjet of submarine and flying automobile operates horizontally and upward or downward according to a preferred embodiment of the present invention.

FIG. 4 is a view for describing an operation during an underwater sailing of a saturated driver's seat while a submarine and flying automobile is sailing underwater according to a preferred embodiment of the present invention;

FIGS. 5A to 5C are views for describing an operation wherein the exhaust gas of submarine and flying automobile according to a preferred embodiment of the present invention is compressed by a piston and is sprayed in the form of bubbles;

FIG. 6 is a view for describing an operation wherein an elevating rudder of a rotation wing of a central shaft of a tandem rotor operates during a flying operation of submarine and flying automobile according to a preferred embodiment of the present invention;

FIG. 7 is a view for describing an operation wherein a screw propeller installed at a trim line operates as a submerging rudder during a submerging operation of submarine and flying automobile according to a preferred embodiment of the present invention;

FIGS. 8A to 8C are views for describing an operation wherein an exhaust pipe and a snorkel exhaust pipe of submarine and flying automobile are separated by a check valve, and a rotation spraying plate exhaust pipe rotation wing operates in horizontal and upward and downward directions according to a preferred embodiment of the present invention; and

FIGS. 9A and 9B are views for describing an operation wherein the configuration of a snorkel intake port and an operation of a buoy of submarine and flying automobile according to a preferred embodiment of the present invention.

### DETAILED DESCRIPTION

The terms used throughout the specification are selected from common terms which are currently and widely being used based on the functions of the present invention and may change depending on a person having ordinary skill in the art or practice or the development of a new technology. Moreover, such terms may be arbitrarily selected by the applicant, in case of which its meaning will be noted in the description of the invention. The terms used throughout the specification should be interpreted based on the actual meaning that a corresponding term has and the whole contexts of the specification, not by the naming of such terms.

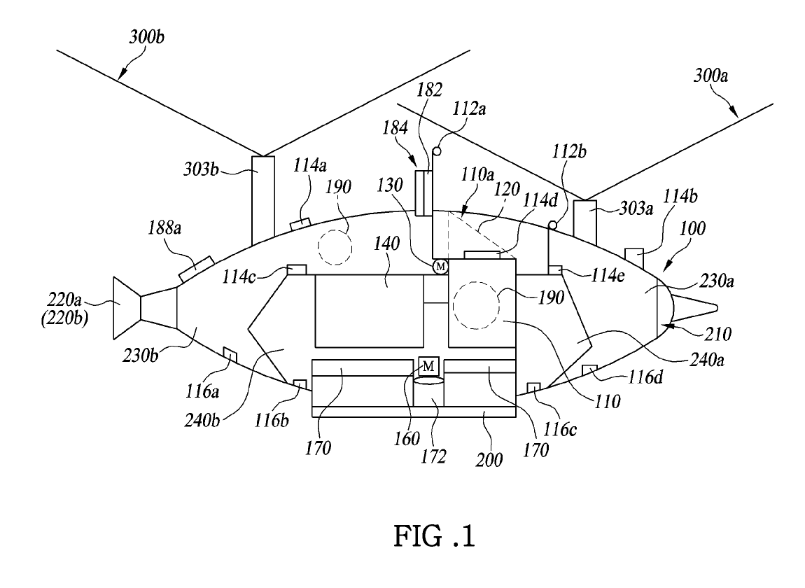

FIG. 1 is a perspective view illustrating the whole exterior of submarine and flying automobile according to a preferred embodiment of the present invention.

Referring to FIG. 1, submarine and flying automobile according to a preferred embodiment of the present invention may include, but is not limited to a submarine-shaped automobile body 100; a waterjet 170 which is installed inside of the automobile body 100 and is able to vertically fly the automobile body 100 in such a way to discharge a previously set water pressure based on a driver's manipulation; a gas turbine engine 140 which is installed inside of the automobile body 100 and is able to fly the automobile body 100 in such a way to generate a predetermined magnitude of a propelling force and a lift based on a driver's manipulation; a pair of tandem rotors 300a and 300b which are installed at a predetermined interval at the top of the automobile body 100 and is able to fly the automobile body 100 in such a way to generate a thrust in the vertical direction based on a driver's manipulation; a bow trim tank 240a and a stern trim tank 240b which are installed at the front and rear portions inside of the automobile body 100 and are configured to store a previously set amount of water so as to adjust the buoyancy with respect to the weights of the front or rear portion of the automobile body 100; and a pair of trim lines 250a and 250b which are configured to connect the bow trim tank 240a and the stern trim tank 240b and are able to forcibly move the water stored in the bow trim tank 240a to the stern trim tank 240b in such a way to use a screw propeller disposed inside or forcibly move the water stored in the stern trim tank 240b to the bow trim tank 240a.

As illustrated in FIG. 1, it is preferred that the exterior of the automobile body 100 is combined with the exteriors of the submarine and the helicopter. Since the underwater weight of the automobile body is reduced by 1/3 on the surface of water, a vertical taking-off and landing operation can be available in such a way that a water stream is gushed above the water up to about 10 meters with the aid of a predetermined water pressure.

Three exhaust pipe propelling parts may be installed at a left portion, a right portion and a rear center portion of the bottom surface of the automobile body 100, whereby a vertical taking-off and landing operation can be available. Inside the automobile body 100, there may be provided a gas turbine engine 140, an underwater motor 160, an air compressor, an exhaust gas compression piston device, and a taking-off and landing float 200.

The taking-off and landing float 200 is shaped like an elliptical waterski which is attached to the automobile body 100, wherein the underwater weight can be reduced when the submarine and flying automobile sails underwater, and when the automobile moves floating underwater, it can slide well on the surface of water, while guiding the same to land in safe on the surface of water.

The exhaust device is equipped with a variable engaging configuration therein, the conversions in the horizontal and upward and downward directions may be available with the aid of the rotation spraying plate exhaust pipe rotation wing 188 in order for the exhaust pipe and the snorkel exhaust pipe to be separated by the check valve, thus changing the direction of the exhaust gas and generating a vertical thrust force. The underwater motor 160 may suck water via the hose 174 and compress the sucked water and spray via the water jet 170, and the upward and downward directions thereof may be changed by the rotation spraying plate drainage port rotation wing 175 attached to the water jet 170, thus changing the direction of water, whereby the automobile can rotate from the rear surface to the surface of the ground and vertically take-off or land on water. Since the automobile body 100 is lifted up with the aid of the water pressure of the water jet 170 and the spraying fluid of the exhaust gas from the gas turbine engine 140, for which less fuel may be used as compared to the conventional taking-off and landing operations.

When the exhaust gas emitted along the upper surface of the automobile body 100 during the underwater sailing is discharged from the rear side of the snorkel exhaust pipe 184, the temperature thereof can be lowered by the cold water on the surface and may be converted into the water drops of the exhaust gas, and the water drops may be compressed by the piston 186 and may be gushed out in the form of fog like foams and air bubbles and may be discharged into water.

For the sake of a perfect waterproof function during the underwater sailing, the automobile body 100 is not equipped with any window. A snorkel intake port 182 is provided, which may allow the automobile to move slowly based on the waterjet propelling part method and the air to be supplied to the gas turbine engine 140. A glass tube formed of a ventilation valve 114e and a windshield glass 121 can pop out of the saturated driver's seat 110 during the flying, thus building a shale 120, so a driver's visual field can be obtained.

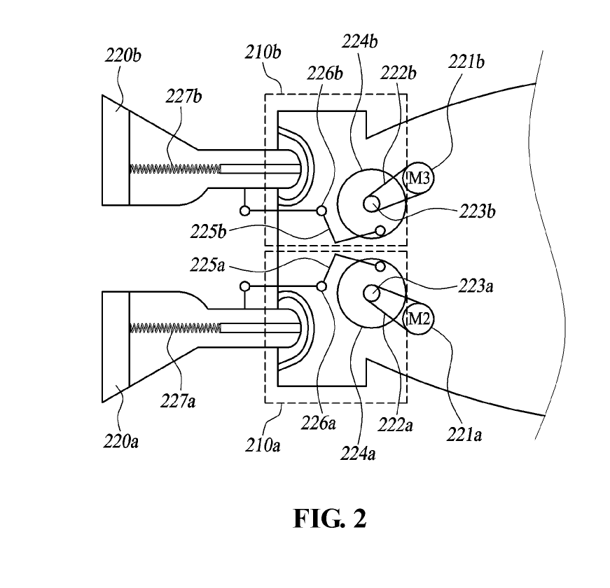

FIG. 2 is a view for describing an operation of a tail wing propelling part which is used during the underwater sailing of a submarine and flying automobile according to a preferred embodiment of the present invention.

Referring to FIG. 2, the tail wing propelling part 220a and 220b may include a pair of electric motors 221a and 221b which are able to generate a torque in a previously set direction if a current is applied; a pair of scotch yokes 210a and 210b which are able to convert the torque generated by a pair of the electric motors 221a and 221b into a reciprocating movement; and a pair of tail wings 220a and 220b which are connected to a pair of the scotch yokes 210a and 210b and operate like the propelling part as the left and right tail wings continue to operate in the left and right reciprocation directions with the aid of a pair of the scotch yokes 210a and 210b.

A pair of the scotch yokes 210a and 210b may include a pair of rocker arms 225a and 225b which are connected to a pair of the tail wings 220a and 220b; a pair of crank shafts 226a and 226b which are connected to a pair of the rocker arms 225a and 225b; a pair of rotation circular plates 224a and 224b which are connected to a pair of the crank shafts 226a and 226b and rotate; and a pair of connection belts 222a and 222b which are configured to transfer the torque from a pair of the electric motors to a pair of the circulation circular plates 224a and 224b.

Here, the tail wings 220a and 220b are able to adjust the forwardly propelling direction in such a way to push surrounding water in the rearward, leftward and rightward directions of the automobile body 100 and are able to carry out a fish fin function which is configured to adjust the leftward and rightward directions of the tail wings 220a and 220b, thus increasing the propelling force of the automobile body 100.

Since the rotation circular plates 224a and 224b can rotate via the driving shafts 223a and 223b connected to the connection belts 222a and 222b which are able to transfer the torque of the electric motors 221a and 221b, if the scotch yokes 210a and 210b convert the rotational motions of the electric motors 210a and 210b into reciprocating motions, the tail wings 220a and 220b connected to the crank shafts 226a and 226b and the rocker arms 225a and 225b may operate like the propelling parts which are able to carry out the reciprocating motions in the leftward and rightward directions.

Referring to FIG. 2, the operation of the tail wing propelling part which is used during the underwater sailing of the submarine and flying automobile will be described according to a preferred embodiment of the present invention.

If one of the tail wings 220a and 220b moves, an eddy current can be generated. A predetermined thrust can generate from the eddy current which is formed moving and passing through water and fluid.

If the other one of the tail wings 220a and 220b flaps, a fluid can be generated in the counter current, thus generating another eddy current. The thusly generated eddy current may spatially move along the automobile body 100 in the direction where the force of the foil formed at the tail wings 220a and 220b moves, wherein the foil means a thin fencing foil the tip of which is formed concave and a flexible fencing foil the tip of which is formed in a blunt rectangular shape.

Moreover, the springs 227a and 227b of the tail wings 220a and 220b are provided with the configuration which may allow to move the automobile body 100 with the aid of the simple flapping of the tail wings 220a and 220b, and the eddy current generating under the sea can be controlled to rotate in the opposite direction in such a way to control the timing where the tail wings 220a and 220b move. The foil is able to transfer the energy generated by the eddy current.

Furthermore, since the tail wings 220a and 220b move in a shape wherein the tail wings slide underwater using the principle of buoyancy, they can operate without additional electric power supply.

The submarine and flying automobile of the present invention is able to generate a high propelling force during an underwater sailing in such a way to use the automobile body 100 and the tail wings 220a and 220b.

Meanwhile, in order to generate a desired propelling force even while using an actuator to which a joint and springs 227a and 227b are engaged, it is preferred that the propelling parts of the tail wings 220a and 220b are made of a flexible material. The actuator is a prime mover which uses an electric hydraulic force, a compressed air, etc. and is an apparatus which is able to do a mechanical operation using a fluid energy.

The propelling parts of the tail wings 220a and 220b may be manufactured using a rigid material, for example, an aluminum, an iron, etc. and a flexible material, for example, a silicon material and a urethane material, thus increasing the propelling force.

Moreover, a stronger propelling force may be obtained in such a way to change the horizontal and vertical ratios of the tail wings 220a and 220b, the elasticity modulus of the spring, etc.

Moreover, since it is possible to design an angle of a bending due to the flexible motion of the joint in such a way to use the force which is transferred from the electric motors 221a and 221b to the tail wings 220a and 220b, the configuration related with the tail wings using the flexible joints is simple, and the manufacturing thereof is advantageously easy.

The driving device, for example, an electric motor may allow to implement a reciprocation motion, and since it is limited by a rotation speed, not the reaction speed of the electric motors 221a and 221b, the revolution can be controlled based on the driving frequency. For example, the angle can be set as a negative value, which is bent in the clockwise direction by setting as the zero point the vertical line which may be drawn downward with respect to the angle set as the central point and bent by the flexible joint, and in case that the angle is bent in the counterclockwise direction, it can be set to have the positive value. If the bent angle may be set as representing that the tail wings 220a and 220b travel one cycle and return to their initial positions, and the operation frequencies of the tail wings 220a and 220b increase, the propelling force may increase, and an additional elastic force may be obtained in such a way to attach the springs 227a and 227b to the tail wings 220a and 220b. In terms of the relation between the angle where the tail wings 220a and 220b are bent, and the propelling force, the instant maximum propelling force may be concurrently obtained at the moment the joints of the tail wings 220a and 220b are bent to their maximums or minimums.

In a state where the head part of the automobile body 100 positions toward the upward or downward direction after the bow ballast tank 230a and the stern ballast tank 230b have been moved back and forth with the aid of the rotational motions of the electric motors 221a and 221b, if the tail wings 220a and 220b reciprocate in the leftward and rightward directions, a predetermined propelling force may occur, so the automobile body 100 can surface or submerge.

Moreover, the automobile is able to turn left with the aid of the pressure of water in a state where the left tail wing 220a stands in the vertical and horizontal directions from the rear side of the automobile body 100 to the front side thereof, and the right tail wing 220b stands in the horizontal and vertical direction, and the automobile is able to turn right with the aid of the pressure of water in a state where the right tail wing 220b stands in the vertical and horizontal directions, and the left tail wing 220a stands in the horizontal and vertical directions. Consequently, the left and right tail wings 220a and 220b may be ascended up upward or downward and then bent and submerged underwater or may be descended downward and bent and may surface from the underwater to the surface of water.

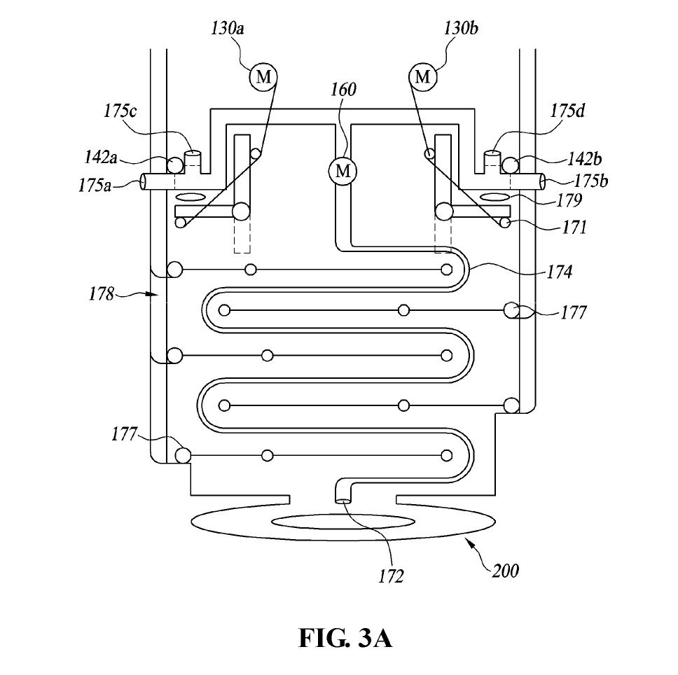

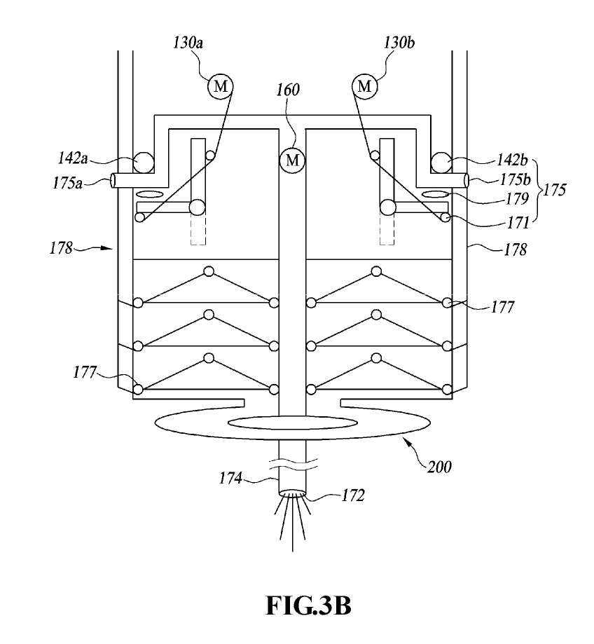

FIGS. 3A and 3B are views for describing an operation wherein the rotation spraying plate drainage port rotation wing of the waterjet of the submarine and flying automobile operate in horizontal and upward and downward directions according to a preferred embodiment of the present invention.

Referring to FIGS. 3A and 3B, the water may be sucked via the intake port of the underwater motor 160 fixed at the lower surface of the waterjet 170, and may be moved in the upward direction via the hose 174 and may be stored in the waterjet 170. In this state, the water stream can be gushed out in the direction of the ground with the aid of the rotation spraying plate drainage port rotation wing 175, so the automobile can vertically take off or land based on the reaction. The rotation spraying plate drainage port rotation wing 175 may be installed near the rotation circular plate 179 and may rotate together with the rocker arm 176, thus manipulating the manipulation surface fixed at the end of each of the drainage ports 175a and 175b.

The horizontal direction conversion of the submarine and flying automobile according to the present invention may be carried out based on the horizontal rotation in such a way that the cable 178 connected to the rotation circular plate 179 is wound or unwound in a state where the rotation spraying plate is fixed like a shower hose, and a bendable end portion of the drainage port is fixed at the top of the rotation circular plate 179.

Moreover, the vertical direction conversion of the submarine and flying automobile according to the present invention may be carried out through an operation wherein an end portion of each of the drainage ports 175a and 175b separates into the horizontal and upward parts by the check valves 142a and 142b, and the horizontal part is closed, and the upper part is opened, thus spraying water.

Meanwhile, the height that the automobile body 100 is able to go up with the aid of the pressure of the waterjet 170 is about 30 feet (10 meters), and 90% of the nozzle spraying amount can be outputted in the form of pressure through the waterjet 170, whereby the direction conversion in the horizontal and upward directions can be carried out by means of the rotation spraying plate drainage port rotation wing.

In this way, the present invention is able to resolve the problem that the waterjet 170 can run at a high speed only when the rocket fuel is used. According to a preferred embodiment of the present invention, the same function can be carried out using water. The waterjet 170 is connected with the hose 174 which is able to supply water with the aid of the underwater motor 160. Since a strong water stream can be gushed out, the submarine and flying automobile according to the present invention can fly in mid-air.

The hose storage part may be installed at a lower portion of the waterjet 170, and the rocker arms 176 of both sides may be attached crossing each other, and the rocker arms 176 are folded horizontal, and it can be folded in an S-shape and can be stored while pushing in the horizontal direction the hose lying in the center.

As described above, referring to FIGS. 3A and 3B, the waterjet 170 is able to take off or land based on the reaction which occurs when water stream is gushed out in the direction of the surface of the ground with the aid of the rotation spraying plate drainage port rotation wing 188 of the gas turbine engine 140 installed inside of the automobile body 100 in a state where the water has been sucked through the intake port of the underwater motor 160 fixed at the lower surface thereof, and the sucked water has been supplied upward via the hose 174 fixed at the lower side of the underwater motor 160 and has been stored in the waterjet 170.

Moreover, the rotation spraying plate drainage port rotation wing 188 may be installed around a pair of the rotation circular plates 224a and 224b disposed at the tail wing propelling part and may rotate together with a pair of the rocker arms 225a and 225b disposed at the tail wing propelling part, so the manipulation surface fixed at an end portion of each of the rotation spraying plate drainage ports 175a and 175b.

Furthermore, the horizontal direction conversion of the waterjet 170 may be carried out through an operation wherein the cable 178 connected to the rotation circular plates 224a and 22b is wound or unwound, thus carrying out a horizontal rotation, in a state where an end portion of each of the rotation spraying plate drainage ports 175a and 175b is fixed at the top of each of the rotation circular plates 224a and 224b, and the vertical direction conversion of the waterjet 170 may be carried out through an operation wherein an end portion of each of the rotation spraying plate drainage ports 175a and 175b separates into the horizontal and upper parts with the aid of the check valves 142a and 142b, and the horizontal part is closed, and the upper part is opened, thus performing the spraying operation.

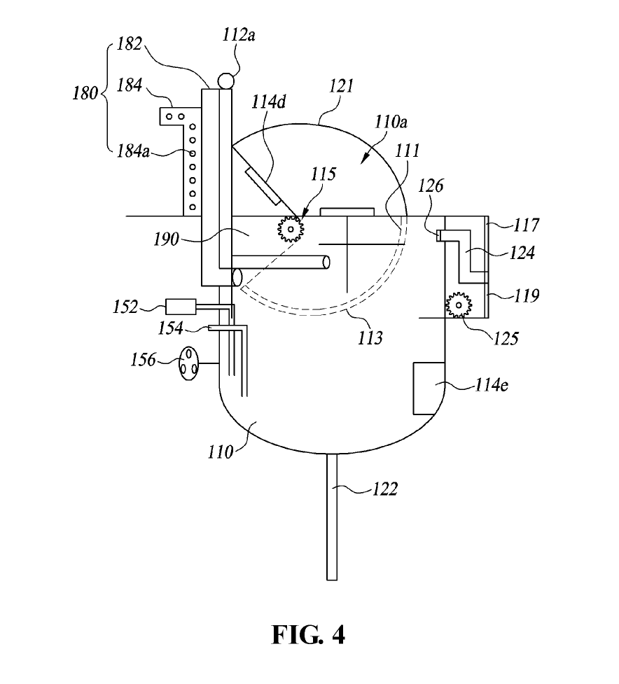

FIG. 4 is a view for describing an operation of the underwater sailing of the saturated driver's seat during the underwater sailing of the submarine and flying automobile according to a preferred embodiment of the present invention.

Referring to FIG. 4, a predetermined air pocket (an air pocket) may be formed since air is filled from the bottom to the top of the saturated driver's seat 110 during the underwater sailing, for which the driver can drive underwater, and even if the automobile body 100 falls into water, the inside portions of the automobile don't get wet.

The saturated driver's seat 110 may include a carbon removing filter 126, a ventilation pipe 124, a door ventilation valve 114d, a shale (the top of a warship) 120, first and second telescopes 112a and 112b, a snorkel exhaust port 184, a horizontal weight 122, a windshield glass 121, a helium gas pack 190, an electrically charged battery and one underwater screw propeller 156. The windshield glass is employed to provide a windshield function to a driver's seat during the flying. An external air and oxygen can be supplied to the saturated driver's seat 110 through the snorkel intake port 182.

The oxygen tank 152 is equipped with a high pressure oxygen cylinder which is configured to compress as much air as possible in a small pipe. If the air in the sealed space is contaminated by the carbon dioxide from the driver, and the oxygen depletes, the oxygen can be supplied through the carbon removing filter 126 connected to the ventilation pipe 124.

In the saturated driver's seat 110 during the flying, the ventilation valve 114d and the windshield glass 121 are raised upward along two rails 117 and 119, thus forming the shale 120, so the driver's visual field can be obtained.

The ventilation valve 114d may be used as a door, and if it is closed in the downward direction for the sake of the ventilation valve 114d, the windshield glass 121 connected to the ventilation valve 114d will descend toward the saturated driver's seat 110 along the rails 117 and 119 and will be stored. Moreover, the ventilation valve 114d and the windshield glass 121 may be connected to each other and may be one glass tube, which can be used so as to obtain a driver's visual field at the saturated driver's seat 110 through the windshield glass 121, instead of the telescope, on the water during the flying.

The air contains of 21% of oxygen and 0.03 of carbon. If the contents of the air in the saturated driver's seat 110 become less than 18%, the oxygen stored in the tank will be supplied. The carbons may chemically reacted and removed using the carbon removing filter 126 wherein chemicals are contained in the ventilation pipe 124 less the contents of the carbon gas exceeds 1%. The carbon dioxide contained inside of the saturated driver's seat 110 may be discharged to the ballast tank 230a installed at the bow through the ventilation pipe 124, and a chemical reaction related with the absorption of the carbon dioxide may create warm water and moisture. In the ballast tank 230a, the carbon dioxide will be removed from the air drops for a long time without any interruption, and it will be discharged through the suction wall.

The lateral pipe valve 154, which is configured to operate like the compressed air valve, will be open so as to additionally supply fresh air, and small sized air bubbles may discharge through the ventilation valve 114d.

Meanwhile, the seawater may be inputted by opening the absorption valves 116c disposed at the bottoms of the ballast tanks 230a and 230b, and carbon dioxide and oxygen will discharge to the outside through the ventilation valves 114e disposed at the tops of the ballast tanks 230a and 230b.

A helium gas pack 190 may be installed on the top inside of the saturated driver's sea 110, wherein the helium gas pack may be configured to operate like the buoyancy device. In this way, the persons can survive for at least 5 hours without any supply of air. If the saturated driver's seat 110 surfaces on the surface of water, the snorkel exhaust port 184 is lifted up, and the ventilation valve 114d installed at the top of the snorkel exhaust port 184 may be open.

The saturated driver's seat 110 should remain horizontal for the sake of the formation of an air pocket. Since the horizontal weight 122 hangs down from an outer portion of the bottom of the saturated driver's seat 110, the weight center can be controlled to position downward, so the saturated driver's seat 110 can easily maintain a horizontal state.

Meanwhile, in case of an emergency situation where the automobile body 100 is sinking, an external cable connected to the manipulation device connected to the saturated driver's seat 110 may be cut along the rails 117 and 119 by a toothed cutter 125, so a connection cable to the outside is disconnected, whereby the saturated driver's seat 110 can separate from the manipulation room and can move freely.

The driver is able to escape in such a way to operate using the battery the screw propeller 156 installed at a bell-shaped turning part formed at a rear bottom surface wherein the horizontal weight 122 is fixed at the lower surface.

Moreover, a door ventilation valve 114e may be installed at a side surface of the bottom of the saturated driver's seat 110, and the door ventilation valve 114d may be installed at the upper end thereof, and a pair of telescopes 112a and 112b having long tubes may be installed at left and right sides, wherein the lengths thereof may extend in the vertical direction over the surface of water inside of the saturated driver's seat 110, whereby a driver's driving visual field can be obtained during the underwater sailing.

The saturated driver's seat 110 may be connected to the compressed air tank via a pipe line into which air can be injected, and the snorkel intake port 182 configured to suck external air may be surfaced over the surface of water, so air necessary to drive the gas turbine engine 140 can be sucked through the snorkel intake port 182, and the compressed air may be stored.

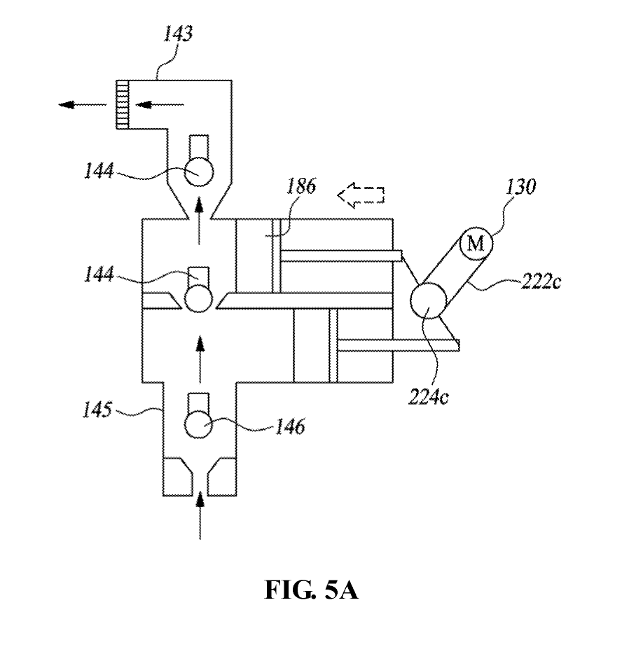

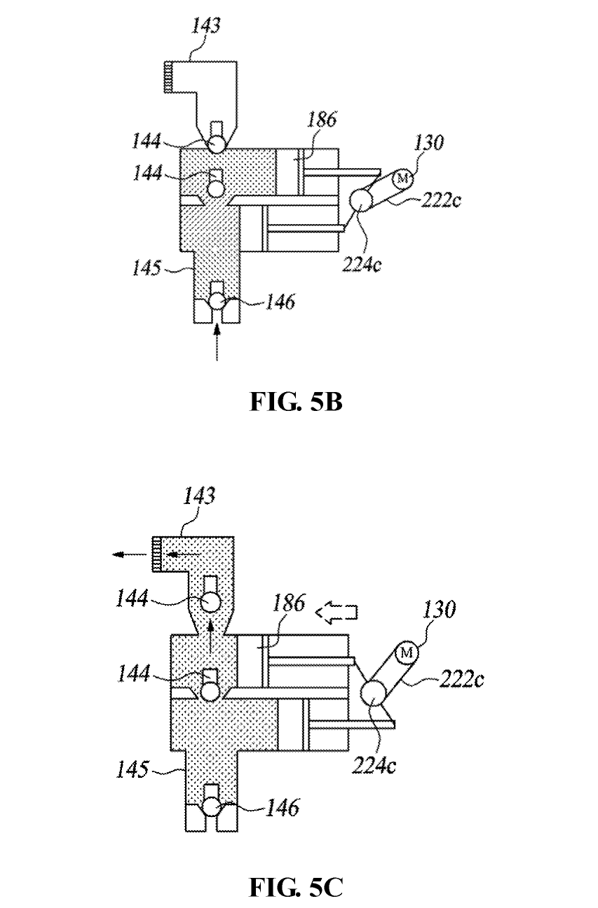

FIGS. 5A to 5C are views for describing an operation wherein the exhaust gas from the submarine and flying automobile is compressed and sprayed in the form of bubbles according to a preferred embodiment of the present invention will be described.

Referring to FIGS. 5A to 5C, the exhaust port may be disposed, using a long straight pipe, on the surface of the automobile body 100 in the direction of the rear side thereof from the gas turbine engine 140. The exhaust gas may be cooled a little by the natural cold of the water on the surface, for which the vapor may turn into water drops, and the micro particles contained in the exhaust gas may combine with the vapor, so the water drops can be easily formed. The snorkel exhaust port 184 may position at the rear side of the shale 120, and the water drops contained in the exhaust gas may be compressed by the piston 186 and may be sprayed like fog in the forms of bubbles (foams and air bubbles) through the small sized exhaust holes 184a of the snorkel exhaust port 184 and may be discharged into water.

Moreover, as an exhaust gas purification catalyst agent, a thickly coated structure formed on a micro honeycomb-shaped stainless or ceramic structure may be used. As the aforementioned catalyst reacts with gas, water may be generated. The key element of the water is one of the products during the combustion procedure. For example, the molecular structure of gasoline is C₈H₁₈, wherein a lot of hydrogens is contained. The carbon reacts with oxygen in air and turns into CO₂, and the hydrogen reacts with oxygen in air and turns into H₂O, thus creating water. Most of the water which can be seen at the end of the exhaust port of the automobile is created during the aforementioned combustion procedure. All the water created during the combustion procedure and the reduction procedure may exist in the form of vapor.

As the exhaust gas is cooled at a low temperature, the vapor may turn into water drops, which may gather at the exhaust port. The water drop may be discharged in the form of vapor unless the exhaust gas is cooled below a dew point of the vapor.

Meanwhile, as the piston 186 is pushed back into the exhaust port so as to compress the water drops of the exhaust gas using the piston 186, the water drops contained in the exhaust gas can be compressed. In this state, since the internal pressure inside of the piston 186 increases, the intake valve 146 through which the exhaust gas water drops pass is closed, thus interrupting the input of water drops, and the discharge valve 144 of the discharge pipe 143 is opened, whereby the water drops contained in the exhaust gas inside of the cylinder can be discharged to the outside.

Meanwhile, if the piston 186 returns to its initial position, the pressure inside of the piston 186 may lower, and the opening and closing of the discharge pipe 143 and the intake pipe 145 may be opposite, and at this time, the water drops contained in the exhaust gas may enter.

Moreover, if the piston 186 compresses, the pressure inside of the piston 186 may be pushed back into the exhaust port, so the water drops contained in the exhaust gas can be compressed. In this way, the pressure of the water drops contained in the exhaust gas filled in the inside of the piston 186 may increase, for which the water drops contained in the exhaust gas can be gushed out in the direction of the discharge pipe 143.

Meanwhile, in order for the water drops contained in the exhaust gas pumped into the discharge pipe 143 to be sprayed in the form of small size particles like fog, the portion through which the water drops in the exhaust gas are sprayed, may be formed of the snorkel exhaust holes 184a in such a way to use a long pipe, thus spraying the water drops in the form of micro sizes. In this way, the water drops can be sprayed into water in the form of small size bubbles (foams and air bubbles) like fog. If the snorkel exhaust holes 184a which operate like the nozzle are connected to the discharge pipe 143, the narrow holes may interrupt the flow of water drops, for which the water drops contained in the exhaust gas flowing toward the nozzle should be pushed out with a high pressure using the piston 186. When the water drops contained in the exhaust gas which have been pushed back with a high pressure, pass through the narrow holes, the water drops will be split into smaller sizes while colliding with seawater. In this way, small sized water drops like fog contained in the exhaust gas can be created.

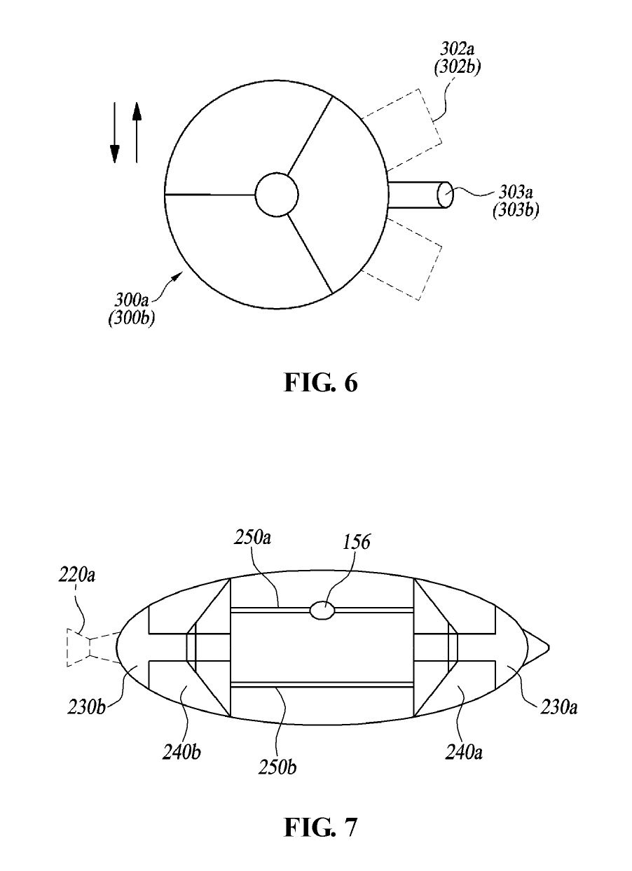

FIG. 6 is a view for describing an operation wherein an elevating rudder of a rotation wing of a central shaft of a tandem rotor operates during the flying in midair of the submarine and flying automobile according to a preferred embodiment of the present invention.

Referring to FIG. 6, as for the functions of the elevating rudder, the cable of the electric motor 130 may wrap the rotation wings 302a and 302b of the central shafts, which are placed on the rotation circular plate by the rotation wings 302a and 302b connected to the central shaft installed at the lower ends of the tandem rotors 300a and 300b (a serial rotor) and may convert to the upward direction, thus raising the front portions of the tandem rotors 300a and 300b. If the cable is released, it may convert to the downward direction, and the front ends of the tandem rotors 300a and 300b can descend.

If the automobile body 100 takes off, when the rotation wings 302a and 302b of the central shafts of the tandem rotors 300a and 300b are lowered, the front portions of the automobile body 100 will be lifted upward, for which a force of pressing downward the rear portions of the automobile body 100 can be generated.

In this way, the front portions of the automobile body 100 may orient in the upward directions of the tandem rotors 300a and 300b, so the attack angle can increase even though the speed is not low, whereby the lift can increase, thus allow the automobile to take off easily. On the contrary, if the rotation wings 302a and 302b of the central shaft of the tandem rotors 300a and 300b are raised upward, the front portions of the automobile body 100 may orient in the downward directions of the tandem rotors 300a and 300b, and the lift can decrease, so the automobile can land on water.

The elevating rudder operated by the rotation wings 302a and 302b is related to the functions of the tandem rotors 300a and 300b which allow to move upward and downward the front portions of the automobile body 100. A pair of the tandem rotors 300a and 300b are supposed to rotate in opposite directions to each other, but any of the tandem rotors 300a and 300b is installed slanted so as to generate the lift in the upward direction, and since the other one rotates in the opposite direction, it is installed slanted in the opposite direction, thus generating the lift in the upward direction.

The aforementioned tandem rotors 300a and 300b are supposed to rotate in opposite directions to each other so as to cancel out the torque. Since the rotation directions of the slanted tandem rotors 300a and 300b are opposite to each other, the flow of the air current may change in such a way that the lower direction rises upward due to reaction.

The rear tandem rotor 300b between the tandem rotors 300a and 300b during the flying of the automobile body 100 may be installed higher than the front tandem rotor 300a, so the rear tandem rotor 300b can move back and forth at the front and rear sides without colliding with each other while they are rotating in midair, for which the whole sizes of the tandem rotors 300a and 300b are same.

Moreover, the functions of the elevating rudder can be obtained in such a way to change a little the angles of the rotation wings 302a and 302b installed at the lower portions of the central shafts of the tandem rotors 300a and 300b during the flying, and the upward and downward directions can be manipulated. Since the front portion of the front tandem rotor 300b is able to move upward and downward based on the functions of the elevating rudder, the tail rings 220a and 220b are able to rotate leftward and rightward based on the function of the vertical rudder.

FIG. 7 is a view for describing an operation wherein the screw propeller installed at the trim line operates like a submerging rudder during the underwater sailing of the submarine and flying automobile according to a preferred embodiment of the present invention.

Referring to FIG. 7, the trim tank may include a bow trim tank 240a and a stern trim tank 240b. The trim lines 250a and 250b are connected to be balanced leftward and rightward about the central point of the automobile body 100. The horizontal state is maintained by moving water based on the inclination of the automobile body 100. The screw propeller 156 installed at the trim lines 250a and 250b connecting the trim tanks 240a and 240b may rotate by the electric motor 130, and water can be discharged backward based on the operation of the rotation wing, so the water in the stern trim tank 240b can move into the bow trim tank 240a, by which the front portion of the automobile portion can become heavier, thus submerging the automobile.

On the contrary, if the water is discharged forward by the operation of the rotation wing in such a way to reversely rotate the screw propeller 156, the water in the bow trim tank 240a will move into the stern trim tank 240b, and the front portion of the automobile body 100 can become lighter, thus surfacing the automobile. If the screw propeller does not work, the bow trim tank 240a and the stern trim tank 240b are connected via the trim lines 250a and 250b, and the water may remain horizontal based on the inclination, by which the automobile body 100 can remain horizontal.

Meanwhile, if the lightness of the automobile body 100 is focused, the buoyancy may increase too high, which makes it hard to submerge underwater deeper. To resolve this problem, the automobile can submerge underwater in such a way to rotate in the reverse direction the rotation wings 302a and 302b of the tandem rotors 300a and 300b, which is opposite to the operation in midair, and it can move by operating underwater the gas turbine engine 140.

As illustrated in FIG. 6, a pair of the tandem rotors 300a and 300b may operate like the screw propeller 156, and the operation of the rotation wings may allow to push backward water like the wind which generates by the rotation of the electric fan, and the automobile body 100 is able to submerge by the reverse operation. If it needs to submerge the automobile, the right tandem rotors 300a and 300b (screw propellers) rotate rightward, and the left tandem rotors 300a and 300b (screw propellers) rotate leftward, more specifically, the left and right sides rotate in the opposite direction, which allows to provide an easier manipulation. Generally speaking, when it needs to change the speed during the submerging, the revolutions of the tandem rotors 300a and 300b (screw propellers) are changed, and when it needs to surface, it can be rotated in the opposite direction.

Meanwhile, a pair of the ballast tanks 230a and 230b and a pair of the trim tanks 240a and 240b are installed at both sides of the automobile body 100. The air compressor may be connected to a pipe which connects the ballast tanks 230a and 230b, and carbon dioxide and air can be discharged via the ventilation valve in a state where the compressed air has been injected in the lateral pipe valve, so the input and output of seawater can be controlled based on reaction, thus maintaining a predetermined buoyancy.

A pair of the ballast tanks 230a and 230b may operate like the buoyancy device since the water is stored in both separately formed passenger compartments without any trim lines in a state where the water does not move. If the water is filled in the ballast tanks 230a and 230b disposed between the outer side and the inner wall of the front and rear portions of the automobile body 100 or is discharged, the automobile body 100 can submerge underwater or can surface upward.

Meanwhile, if the absorption valve disposed at the bottoms of the ballast tanks 230a and 230b is open and water enters as the operator manipulates when the automobile body 100 needs to submerge, the air in the ballast tanks 230a and 230b may be discharged via the ventilation valve disposed at the tops of the ballast tanks 230a and 230b, for which the automobile body 100 becomes heavier and can submerge underwater.

Moreover, in case where the automobile body 100 surfaces, if the ventilation valves disposed at the tops of the ballast tanks 230a and 230b are closed, the lateral valves of the ballast tanks 230a and 230b are opened, and the compressed air is supplied, so the seawater can be pushed back into the sea via the absorption valve disposed at the bottom, whereby the automobile body 100 can become lighter and can surface over the surface of the water.

The ventilation valves represents a simple valve which is attached to the apex of a hot air balloon. It is a kind of a ventilation valve that a person in the hot air balloon can open to input gas or air, thus gradually moving the balloon upward.

Moreover, the ballast tanks 230a and 230b represent parallel water tanks. If the automobile moves in a boundary state, the absorption values of the bottoms of the ballast tanks 230a and 230b are opened, so the seawater can always enter or go out of the ballast tanks 230a and 230b and the trim tanks 240a and 240b of the bow and stern of the automobile.

Since the seawater can rush inside via the absorption valve disposed at the bottoms of the ballast tanks 230a and 230b of the bow and stern, the micro size vapor from the ventilation pipe may mix with the carbon dioxide discharged through the ventilation pipe from the saturated driver's seat 110 and may be discharged at a high speed in the direction of the surface of the water, which looks like a high pressure vapor gushes out.

Meanwhile, it is preferred to carry out a predetermined action to shake the front and rear sides of the automobile body 100 in a dolphin shape 3 or 4 times in order to prevent the air bubbles or air from remaining inside of the ballast tanks 230a and 230b during the underwater flying.

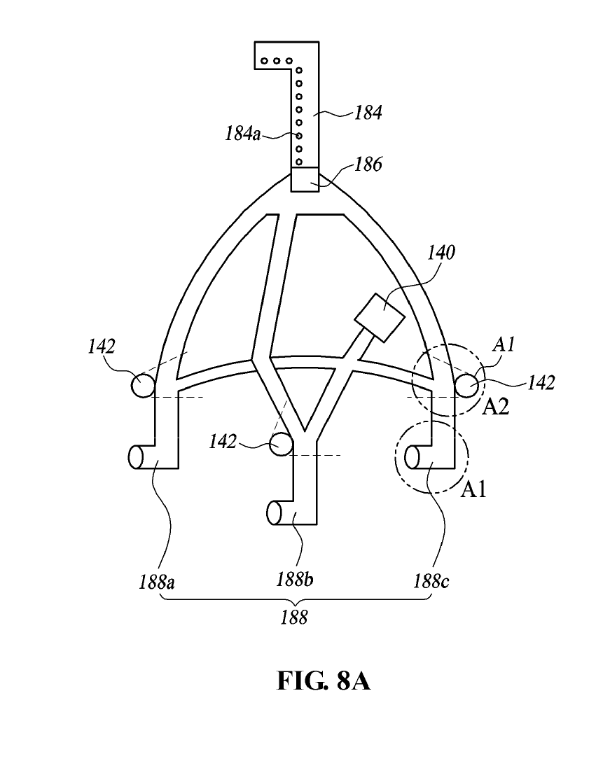

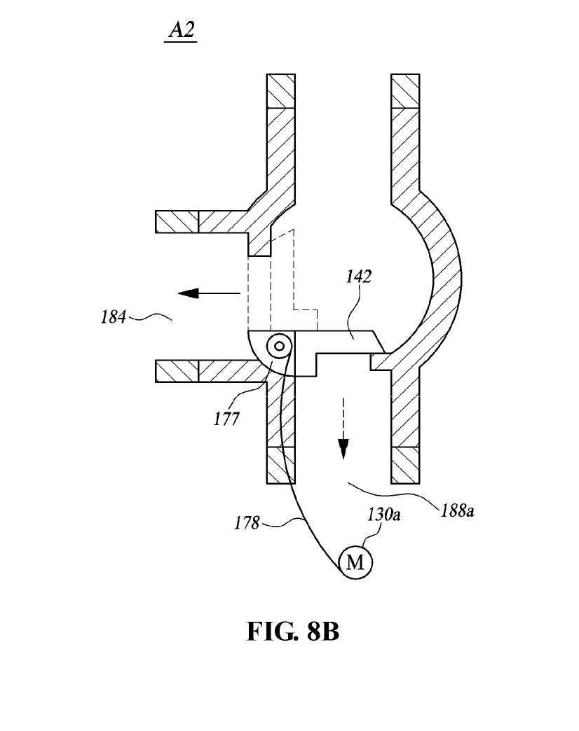

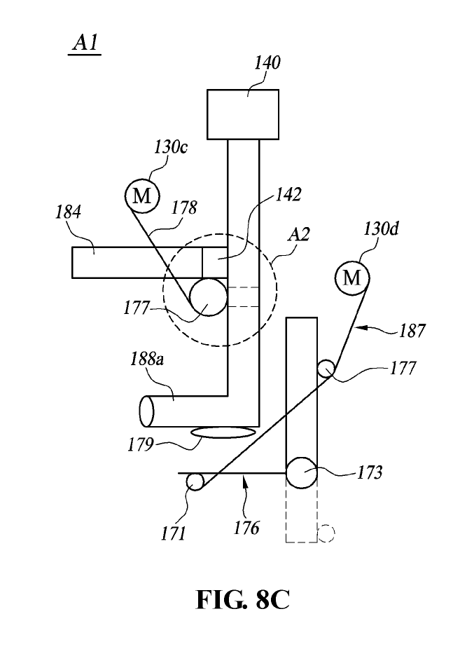

FIGS. 8A to 8C are views for describing an operation wherein the exhaust port and the snorkel exhaust port of the submarine and flying automobile separate by a check valve, and the rotation spraying plate exhaust port rotation wing operates in the horizontal and upward and downward directions according to a preferred embodiment of the present invention.

As illustrated in FIGS. 8A to 8C, the exhaust port is disposed at the rear and left and right portions and is able to change direction from the rear surface to the surface of the ground with the aid of the rotation spraying plate exhaust port rotation wing 188 of the gas turbine engine 140 when it needs to surface in the vertical direction, and the automobile is able to surface in the vertical direction by gushing out the exhaust gas, and two nozzles disposed at the front side of the automobile body 100 may stand upright vertical, and the air can be sprayed from upward to downward, so it can surface in the vertical direction. Thereafter, the direction to the surface of the ground can change to the rear surface by means of the rotation spraying plate exhaust port rotation wing 188, and the exhaust gas is sprayed, so the automobile can fly with the aid of propelling force.

Meanwhile, the check valve 142 may operate to allow the fluid to flow in one direction, and the check valve itself can be closed by the negative pressure of the fluid when the fluid stops, thus preventing any reverse flow.

Moreover, the exhaust gas discharged from the gas turbine engine 140 may be divided and discharged into two parts through the exhaust ports 188a, 188b and 188c and the snorkel exhaust port 184 by means of the check valve 142 installed where the exhaust ports 188a, 188c and 188c and the snorkel exhaust port 184 are divided.

The check valves 142, 142a, 142b, 142c and 142d are connected to the exhaust pope passage connected to the intake pipe 145 and the discharge pipe 143 through a pulley 177 and the cable 178. As the cable 178 is wound by the electric motor 130, the snorkel exhaust port 184 is closed, and the rotation spraying plate exhaust ports 188a, 188b and 188c are open and spray exhaust gas.

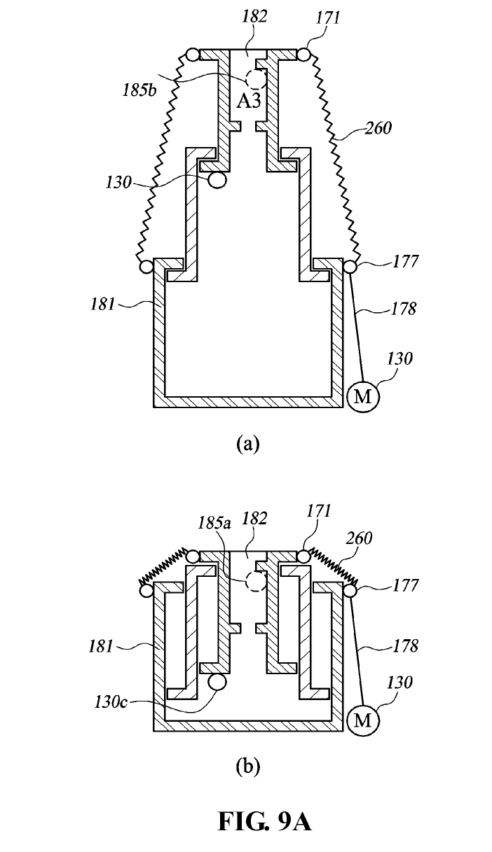

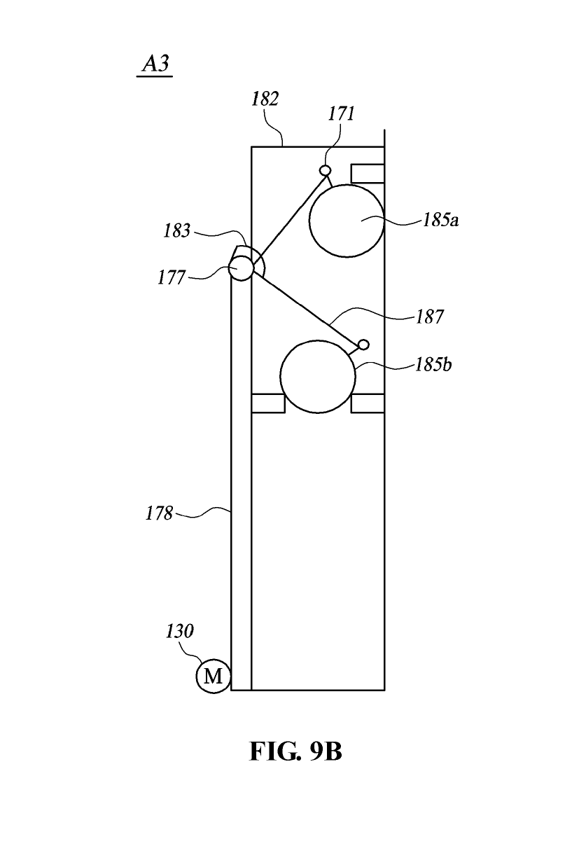

As illustrated in FIG. 9, as the cable 178 is released by means of the electric motor 130, and the check valve 184 is closed, and it is opened in the direction of the snorkel exhaust port 184, thus spraying the exhaust gas. The rotation circular plate 179 is attached to the lower surfaces of the exhaust ports 188a, 188b and 188c of the rotation spraying plate, so the cable 178 can be wound and released, thus moving in the horizontal direction the snorkel exhaust port 184.

Meanwhile, the crank shaft 173, the rocker arm (not illustrated), and the cable 178 may be engaged to the lower surface of the rotation circular plate 179. If the cable 178 is wound, the rotation spraying plate exhaust port 188 may be raised upward, and if the cable 178 is released, it may be lowered in the direction of the surface of the ground. The rotation spraying plate exhaust port rotation wing 188 of the gas turbine engine 140 may be installed at the lower surface of the rotation spraying plate exhaust port 188 and may move horizontally toward the rotation circular plate 179 and may move vertically toward the rocker arm and the crank shaft 173 attached to the lower surface of the rotation circular plate 179.

FIGS. 9A and 9B are views for describing an operation wherein the configuration of a snorkel intake port and an operation of a buoy of an automobile equipped with submarine and flying automobile according to a preferred embodiment of the present invention.

Referring to FIGS. 9A and 9B, the snorkel 180 configured to suck air on the surface of water is provided to obtain air in the underwater less the device extends to the outside of water. More specifically, the snorkel intake port 182 may be engaged at the seat of the saturated driver's seat 110 during the underwater sailing so as to suck air and supple into the indoor space wherein the sucked air is used for a driver's breathing and engine combustion.

Meanwhile, the check valve 142e may be disposed at an upper portion of the snorkel 180 so as to interrupt the input of water during the underwater sailing of the automobile body 100, and the buoys 185a and 185b may hang from the snorkel pipe 181 below the same. In this state, if water enters the snorkel pipe 181, the buoys 185a and 185b may descend downward from the snorkel pipe 181 by means of the water pressure, so the snorkel pipe 181 is blocked, whereby the water does not move downward.

Meanwhile, the compressed air may be supplied from the bottom of the snorkel pipe 181 to the top thereof during the operation on water of the automobile body 100, so the buoy 185a attached to the spring 183 can move upward and can be fixed by the spring 183, whereby the air can flow.

Moreover, if the driver pushes the exhaust button so as to remove the water from the snorkel 180 in a state where the compressed air has been oriented upward, the compressed air can be gushed out, thus removing the water.

Since the rim of the snorkel 180 is wrapped by a flexible rubber container, it can have waterproof. The snorkel 180 may be engaged in multiple stages inside of the flexible rubber container and may be connected by means of the ring 171 and the pulley 177, wherein the cable 178 of the electric motor 130 is attached to the top of the snorkel 180. As the cable 178 is wound, the snorkel 180 can extend and move upward, and as the cable 178 is released, the snorkel 180 can be folded downward and descend.

The snorkel 180 can be configured in multiple stages, more specifically, three or more than three stages, and can be connected with the saturated driver's seat 110. In this way, the snorkel 180 can be used after it has been lifted on the upper layer in multiple stages.

Meanwhile, the total length of the snorkel 180 may be about 3 meters, and if the three stages thereof are assembled, it is possible to submerge in a river having a depth of about 5 meters. The snorkel may be manufactured with different diameters so that each stage can be folded for the sake of easier loading and transportation on an ordinary vehicle.

The operations of the submarine and flying automobile when it fly or submerges according to a predetermined embodiment of the present invention will be described with reference to the accompanying drawings.

In order for the submarine and flying automobile to take off vertically, the hose 174 connected to the lower side of the underwater motor 160 should be lowered in accordance with a driver's low height flying control, and water is sucked through the waterjet pack intake port 172, and it is forcibly lifted upward, and the water is stored inside of the waterjet 170. In this state, the stored water is discharged while changing the direction from the rear surface to the surface of the ground in such a way to use the rotation spraying plate drainage port rotation wing 175 of the waterjet 170, and the submarine and flying automobile is able to fly at a height of about 10 meters with the aid of the pressure of discharging water, and at the same time, the driver is able to rotate horizontally the rotation wings 302a and 302b by controlling the tandem rotors 300a and 300b. In a state where the direction of the rotation spraying plate exhaust port rotation wing 188 of the gas turbine engine 140 installed inside of the automobile body 10 has been changed from the rear surface to the surface of the ground, the automobile is able to fly low at a height of about 20 meters over water with the aid of propelling force.

Meanwhile, for the sake of an underwater sailing, the driver needs to control the rotation directions of the tandem rotors 300a and 300b, and the left tandem rotor 300b is rotated in the leftward direction, and the right tandem rotor 300a is rotated in the rightward direction, thus obtaining a propelling operation wherein the automobile body 100 is pushed from the upward to downward directions, and the water stored in the stern trim tank 240b can move to the bow trim tank 240a with the aid of the screw propeller 156 installed at the trim lines 250a and 250b, so the weight of the front side of the automobile body 100 becomes relatively heavier than the weight of the rear side thereof, whereby the automobile body 100 can be tilted downward and will submerge. Moreover, for the sake of an underwater sailing, the torques of the electric motors 221a and 221b are converted into the left and right reciprocating motions of a pair of the tail wings 220a and 220b using the scotch yokes 210a and 210b, thus continuously providing a propelling force. In this way, the automobile body 100 can be manipulated underwater in the vertical and horizontal directions.

For the underwater sailing, the automobile may turn left by blocking a waterway in a state where the left tail wing 220a stands in the vertical and horizontal directions, and the right tail wing 220b stands in the horizontal and vertical directions, and on the contrary, the automobile may turn right by blocking the waterway in a state where the right tail wing 220b stands in the vertical and horizontal directions, and the left tail wing 220a stands in the horizontal and vertical directions. In this way, the automobile is able to submerge up to about 10 meters.

Moreover, the left and right tail wings 220a and 220b may be lifted upward and bent when it needs to submerge, and may be lowered downward and bent when it needs to surface.

Meanwhile, the driver is able to wear the oxygen tank 152 in the saturated driver's seat 110, thus receiving oxygen, and since the carbon removing filter 126 is installed at the ventilation pipe 124, the air supplied to the driver can be supplied after it has been filtered. The exhaust gas generating at this moment can be cooled by the temperature of the water itself supplied through the long pipe installed at the surface of the top of the automobile body 100, and the exhaust gas can be cooled and discharged into water drops and can be compressed by the piston 186 and can be sprayed into water like fog in the form of bubbles (foams and air bubbles) through the micro size exhaust holes 184a formed at the snorkel exhaust port 184.

The submarine and flying automobile according to a preferred embodiment of the present invention is able to vertical take-off or land on water with the aid of the pressure of water discharged from the waterjet. For the underwater sailing, since the water stored in the stern trim tank can be forcibly moved to the bow trim tank by means of the screw propeller installed at the trim lines 250a and 250b, the automobile body is able to submerge, and for the underwater flying, the ascending and descending and left and right and horizontal directions can be manipulated using the left and right tail wings.

If the submarine and flying automobile according to the present invention is commercialized, it can be first used for leisure or military purpose, and since such an automobile is not commercialized throughout the world, it is expected to be the first mover in the markets based on a market differentiation.

Moreover, in the recent trend wherein the demand for a private yacht and helicopter is strong among rich persons, it is expected that the present invention may receive a lot of interest as a new water leisure sport since the submarine and flying automobile is able to take-off and land on water using a small area and is able to sail underwater at a low speed along complicated topography and is able to stay in one place and is able to freely fly over water, if necessary.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A submarine and flying automobile,is comprising:
a submarine-shaped automobile body;
a waterjet which is installed inside of the automobile body and is able to vertically fly the automobile body in such a way to discharge a previously set water pressure based on a driver's manipulation;
a gas turbine engine which is installed inside of the automobile body and is able to fly the automobile body in such a way to generate a predetermined magnitude of a propelling force and a lift based on a driver's manipulation;
a pair of tandem rotors which are installed at a predetermined interval at the top of the automobile body and is able to fly the automobile body in such a way to generate a thrust in the vertical direction based on a driver's manipulation;
a bow trim tank and a stern trim tank which are installed at the front and rear portions inside of the automobile body and are configured to store a previously set amount of water so as to adjust the buoyancy with respect to the weights of the front or rear portion of the automobile body;
a pair of trim lines which are configured to connect the bow trim tank and the stern trim tank and are able to forcibly move the water stored in the bow trim tank to the stern trim tank in such a way to use a screw propeller disposed inside or forcibly move the water stored in the stern trim tank to the bow trim tank;
a tail wing propelling part which is engaged to a rear portion of the automobile body and is configured to convert the torque of an electric motor into leftward and rightward reciprocation movements using a scotch yoke during an underwater sailing, thus continuously supplying a propelling force and is able to manipulate underwater the automobile body in the vertical and horizontal directions, wherein the tail wing propelling part includes:
a pair of electric motors which are able to generate a torque in a previously set direction if a current is applied;
a pair of scotch yokes which are able to convert the torque generated by a pair of the electric motors into a reciprocating movement; and
a pair of left and right tail wings which operate like the propelling part as the left and right tail wings continue to operate in the left and right reciprocation directions with the aid of a pair of the scotch yokes.

2. The automobile of claim 1, wherein a pair of the scotch yokes include:
a pair of rocker arms which are connected to a pair of the tail wings;
a pair of crank shafts which are connected to a pair of the rocker arms;
a pair of rotation circular plates which are connected to a pair of the crank shafts and rotate; and
a pair of connection belts which are configured to transfer the torque from a pair of the electric motors to a pair of the circulation circular plates.

3. The automobile of claim 1, wherein the automobile turns left by the pressure of water in a state where the left tail wing stands in the vertical and horizontal directions toward the rear to front portions of the automobile body and the right tail wing stands in the horizontal and vertical directions, and the automobile turns right by the pressure of water in a state where the right tail wing stands in the vertical and horizontal directions and the left tail wing stands in the horizontal and vertical directions, and the automobile is able to submerge underwater in such a way that the left and right tail wings are lifted in the upward and downward directions and are bent and is able to surface from the underwater to the surface of water in such a way that the left and right tail wings are lowered downward and bent.

4. The automobile of claim 1, wherein the waterjet is able to vertically take-off or land on water with the aid of the reaction when water stream is gushed out in the direction of the ground by means of a rotation spraying plate drainage port rotation wing of the gas turbine engine installed inside of the automobile body in a state where water is sucked through an absorption port of an underwater motor fixed at the lower surface of the waterjet, and is supplied in the upward direction through a hose connected to the lower side of the underwater motor and is stored in the waterjet; and the rotation spraying plate drainage port rotation wing is installed around the rotation circular plate provided at the tail wing propelling part and is configured to rotate together with the rocker arms disposed at the tail wing propelling part, and a manipulation surface fixed at an end portion of the rotation spraying plate drainage port is manipulated; and
the horizontal direction conversion of the waterjet can be carried out in such a way that a horizontal rotation is performed as a cable connected to the rotation circular plate is wound or released in a state where an end portion of the rotation spraying plate drainage port is fixed at the top of the circulation circular plate; and the vertical direction conversion of the waterjet can be carried out through an operation wherein the end portion of the rotation spraying plate drainage port separates into a horizontal part and a top part by means of a check valve, and the horizontal part is closed, and the top part is opened, thus spraying water.
